(19) United States
(12) Patent Application Publication
(10) Pub. No.: US 2008/0169395 A1
(43) Pub. Date: Jul. 17, 2008

(54) Reconfigurable hook assembly

(76) Inventor: Charles E. Bullock, Waukegan, IL (US)

Correspondence Address: BRINKS HOFER GILSON & LIONE, P.O. BOX 10395, CHICAGO, IL, 60610, US

(21) Appl. No.: 11/654,399

(22) Filed: Jan. 16, 2007

(51) Int. Cl. A47B 96/07; F16B 45/00

(52) U.S. Cl. 248/304; 248/215; 248/205.1

(57) ABSTRACT

A hook assembly includes a mounting member having an opening defining a vertical axis. A hook member is removeably secured to the mounting member through the opening. In one embodiment, the mounting member includes a retainer slideably coupled to a mounting rail, with the retainer slideable along the mounting rail in the longitudinal direction to a plurality of positions. A method of assembling a hook assembly includes mounting a mounting member to a surface defining a plane and successively threading a hook portion and a shaft portion of a J-shaped hook member through an opening in the mounting member without breaking the plane with the hook member.

### FIELD OF THE INVENTION

The present invention relates generally to a hook assembly, and in particular, to a hook assembly that is reconfigurable.

### BACKGROUND

J-shaped hooks are commonly used for holding various items. For example, such hooks are often installed inside a trailer. Typically, each hook is permanently installed at a single, fixed location. For example, a straight rod can be inserted through aligned holes in a C-shaped channel, with the lower end of the rod bent, e.g., twice, after insertion to form a hook portion. The hook is thereby permanently installed and cannot be removed from the channel, or moved longitudinally along its length. As such, if the hook is damaged, e.g., broken or bent, it can be difficult and expensive to repair or replace.

### SUMMARY

The present invention is defined by the following claims, and nothing in this section should be considered to be a limitation on those claims. By way of introduction, the embodiment of a hook assembly described below may be connected to any component. For example and without limitation, the hook assembly can be mounted on any wall or mounting surface, such as a trailer wall, or on a rack, frame or other support structure.

In one embodiment, the hook assembly includes a mounting member having vertically spaced upper and lower flanges. The upper flange has a first opening and the lower flange has a second opening aligned with the first opening in the vertical direction. The first opening has a first shape and the second opening has a second shape, with the first shape being different than the second shape. A hook member includes a head portion and a hook portion. The hook member is removeably secured to the mounting member through the first and second openings. The hook portion of the hook member is moveable through the first and second openings as the hook member is moved from a disengaged position to an engaged position, with the head portion engaging the upper flange.

In another aspect, one embodiment of the hook assembly includes a mounting rail extending in a longitudinal direction. The mounting member includes a retainer slideably coupled to the mounting rail, with the retainer slideable along the mounting rail in the longitudinal direction to a plurality of positions. The retainer has an opening defining a substantially vertical axis. A hook member is removeably secured to the retainer through the opening. The hook is moveable through the opening from a disengaged position to an engaged position while the retainer is coupled to the mounting rail.

In another aspect, a method of assembling a hook assembly includes mounting a mounting member to a surface defining a plane and successively threading a hook portion and a shaft portion of a J-shaped hook member through an opening in the mounting member without breaking the plane with the hook member. The method also includes engaging the mounting member with a head portion of the hook member.

The various aspects and embodiments provide significant advantages. In particular, a hook member can be easily installed and removed without any additional shaping or forming of the hook member. In addition, in one embodiment, the hook member can be fixed at a plurality of rotational positions relative to a vertical axis. In one embodiment, the hook member can be moved to a plurality of longitudinal positions. In one embodiment, the position of the hook member is infinitely adjustable along the longitudinal direction. As such, the various embodiments provide additional flexibility in positioning the hook member, both by rotating and translating the hook member. In addition, the hook member can be easily and inexpensively replaced without any tools.

The foregoing paragraphs have been provided by way of general introduction, and are not intended to limit the scope of the following claims. The various preferred embodiments, together with further advantages, will be best understood by reference to the following detailed description taken in conjunction with the accompanying drawings.

### BRIEF DESCRIPTION OF THE DRAWINGS

FIG. 1 is a partial perspective view of a first embodiment of a hook assembly.

FIG. 2 is a top view of the hook assembly shown in FIG. 1.

FIG. 3 is an enlarged perspective view of a hook assembly.

FIG. 4 is a perspective view of a first embodiment of a mounting rail.

FIG. 5 is a perspective view of a hook member.

FIG. 6 is a perspective view of one embodiment of a mounting member.

FIGS. 7A and 7B are side and top views respectively of a second embodiment of a mounting rail.

FIG. 8 is a front view of a second embodiment of a hook assembly.

FIG. 9 is a side view of the hook assembly shown in FIG. 8.

FIG. 10 is a top view of the hook assembly shown in FIG. 8.

FIG. 11 is an exploded perspective view of a third embodiment of a hook assembly.

FIG. 12 is an assembled perspective view of the hook assembly shown in FIG. 11.

FIG. 13 is a perspective view of a second embodiment of a mounting member.

FIG. 14 is a perspective view of a third embodiment of a mounting member.

FIG. 15 is a perspective view of a fourth embodiment of a mounting member.

FIG. 16 is a perspective view of a fifth embodiment of a mounting member.

FIG. 17 is a perspective view of a sixth embodiment of a mounting member.

FIG. 18 is a perspective view of a retainer clip.

### DETAILED DESCRIPTION OF THE PRESENTLY PREFERRED EMBODIMENTS

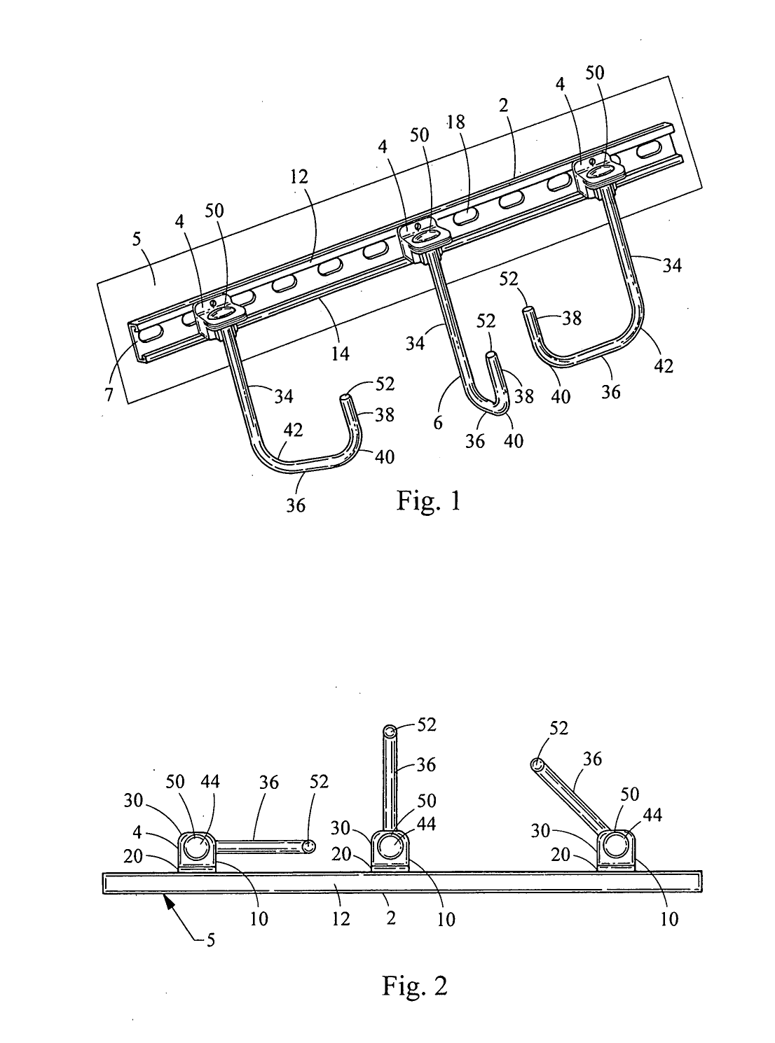

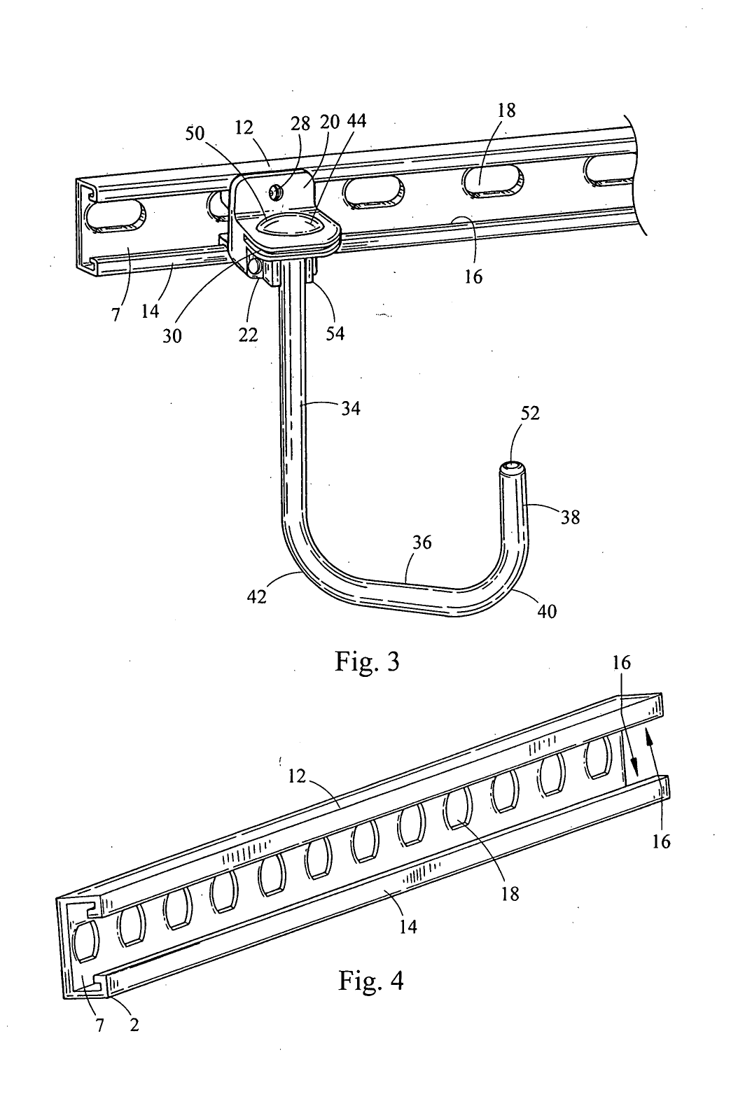

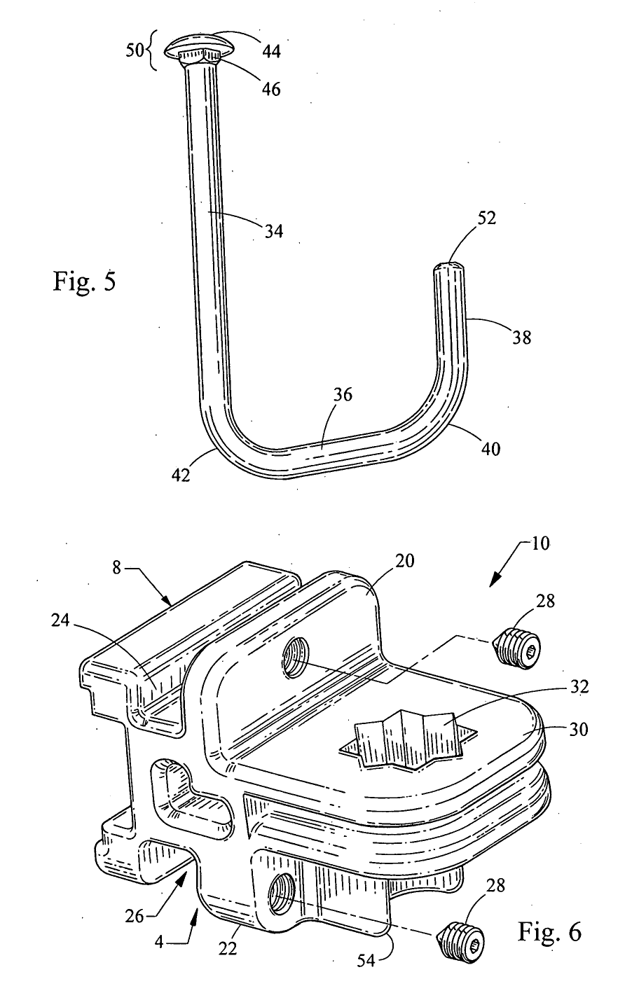

Referring to FIGS. 1-6 and 12-17, various embodiments of a hook assembly include a mounting rail 2, a mounting member 4 and a hook member 6. The mounting rail, mounting member and hook member can be made of various materials, including metal, for example and without limitation steel, aluminum, stainless steel, etc. The mounting rail can be made as an extrusion, by roll forming, etc. The mounting member can be made as a metal casting, including for example a zinc die cast, steel, aluminum, etc., as well as from plastic, for example and without limitation injection molded plastic.

The mounting rail has a C-shaped cross section with upper and lower flanges 12, 14 forming a pair of opposite tracks 16 in one embodiment. A rear wall 7 of the mounting rail 2 is mounted to a support member having a surface defining a plane 5, such as a wall or frame, for example in a trailer. The mounting rail 2 is secured to the support member with mechanical fasteners extending through openings in the mounting rail or by other mechanical means, adhesives, welding, or combinations thereof. The mounting rail 2 is preferably positioned in a horizontal orientation, although it should be understood that it can be arranged in other orientations, including a vertical or oblique orientation. In one embodiment, the mounting rail 2 includes a plurality of lightening holes 18 formed in the rear wall 7, which do not adversely affect the strength of the rail. Of course, the mounting rail can be formed without the holes 18, or with other holes having different shapes and patterns.

The mounting member 4 is preferably configured as a retainer having an insert portion 8 and a mounting portion 10. As shown in the embodiment of FIGS. 1, 3 and 6, the insert portion 8 and mounting portion 10 are integrally formed. As shown in the embodiment of FIGS. 12-17, the mounting portion 108 is formed separately from the insert portion 110. In either embodiment, the insert portion 8, 108 is disposed in the pair of tracks 16 formed by the mounting rail and is moveable, e.g., slideable, along the length of the mounting rail to any position, such that it is infinitely adjustable. The insert portion 8, 108 is inserted through an end of the mounting rail, with the flanges trapping the insert portion such that it cannot be removed through the front of the rail.

As shown in FIG. 6, the mounting portion 8 includes a pair of flanges 20, 22 that define a pair of channels 24, 26 that receive the flanges 12, 14 of the mounting rail. A lock member 28, shown as a plurality of set screws, is threadably engaged with the flanges 20, 22 and can be secured against the flanges 12, 14 of the mounting rail so as to lock the mounting member in a desired position relative to the mounting rail. The flanges 20, 22 further absorb some of the load as they bear against the mounting rail. The term “plurality” as used herein means two or more.

The mounting portion 10 further includes a mounting platform 30 having a opening 32 formed therethrough. The opening 32 preferably has a polygonal shape, including for example and without limitation a star shape, a hexagon shape, a pentagon shape, a square shape, etc. The opening can also be configured as a D-shape, or any shape that mates with another cross-section so as to prevent relative rotation between the two members. In another embodiment, where rotation is desired, the opening can have a circular cross-section. Beneath the mounting platform, the mounting portion includes a U-shaped socket 54 that receives and stabilizes a shaft 34 of a hook member. The socket 54 has an interior surface with a shape substantially the same as the exterior surface of the shaft 34. For example, the interior surface has a radius substantially the same as the radius of the shaft 34. Of course, the radius of the shaft may be slightly smaller than the radius of the interior surface so as to avoid an interference fit.

Referring to FIGS. 1, 2, 3 and 5, the hook member 6 includes the shaft 34, oriented substantially vertically in a preferred embodiment, a hook portion 48 and a head portion 50. The hook member is preferably J-shaped. In one embodiment, the hook portion 48 includes a substantially linear horizontal portion 36 and a substantially linear vertical portion 38 joined by a curved portion 40. In addition, the horizontal portion of the hook portion is joined to the shaft 34 by a curved portion 42. In other embodiments, the entirety of the hook portion is curved.

The hook member, and in particular the head portion 50, includes a cap 44 and a locator 46 positioned beneath the cap. The locator 46 has a shape that mates with the shape of the opening 32 in the mounting portion, for example a mating, but not necessarily identical, polygonal shape. The cap 44 has a width or surface area greater than the opening 32, such that it bears against the top of the mounting portion once the hook member is installed on the mounting member.

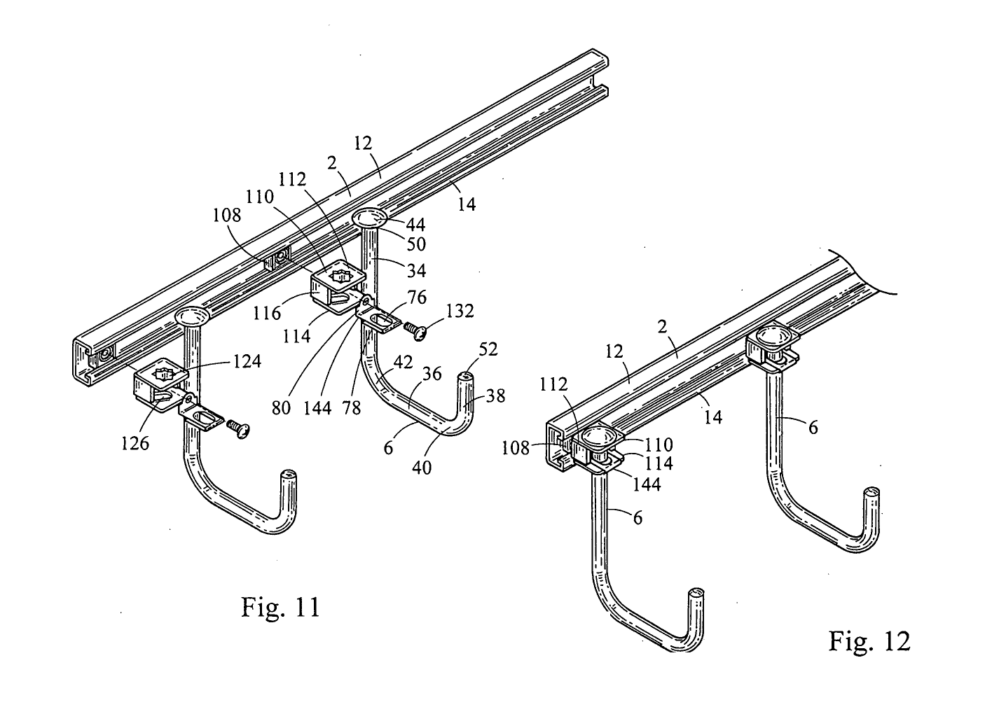

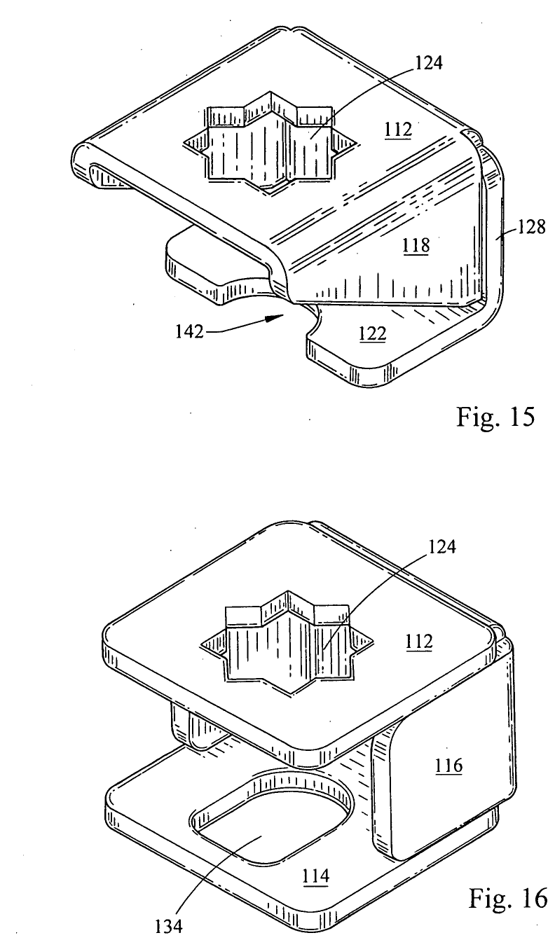

Referring to FIGS. 11-18, the mounting portion 110 is configured with a pair of flanges 112, 114 spaced apart in the direction of the shaft. The upper flange 112 includes a first opening 124 shaped to receive the locator 46, for example, a polygonal shape. The lower flange 114 includes an elongated second opening 126, or slot which is preferably a different shape than the first opening. The flanges 112, 114 extend outwardly from a rear wall 128. As shown in the embodiments of FIGS. 12, 13 and 16, a pair of side walls 116 also extend forwardly from the rear wall to form a box-like structure. Alternatively, as shown in FIG. 15 the side walls 118 extend downwardly from the upper flange 112. In yet another alternative, shown in FIG. 14, one or more brace members 120 are formed between the upper flange 112 and the rear wall 128. The various side walls and brace members increase the strength of the mounting portion and prevent the upper flange from bending in response to a load applied thereto from the hook member when loaded.

An opening 130 is formed in the rear wall 128. A screw 132 is inserted through the opening and secures the mounting portion 110 to the insert member 110. When tightened, the screw further locks the mounting member in place relative to the mounting rail.

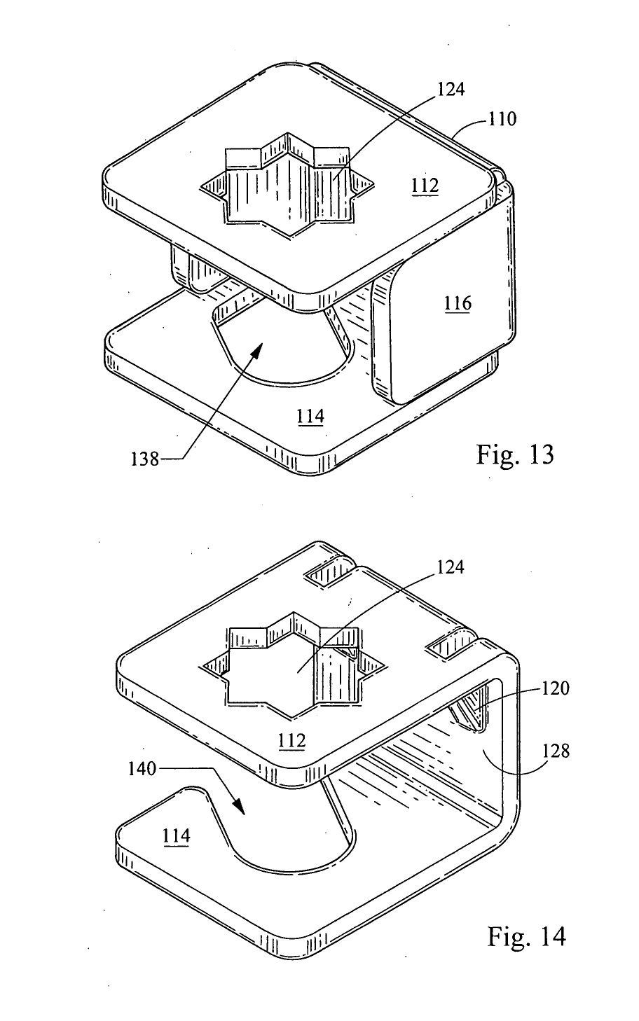

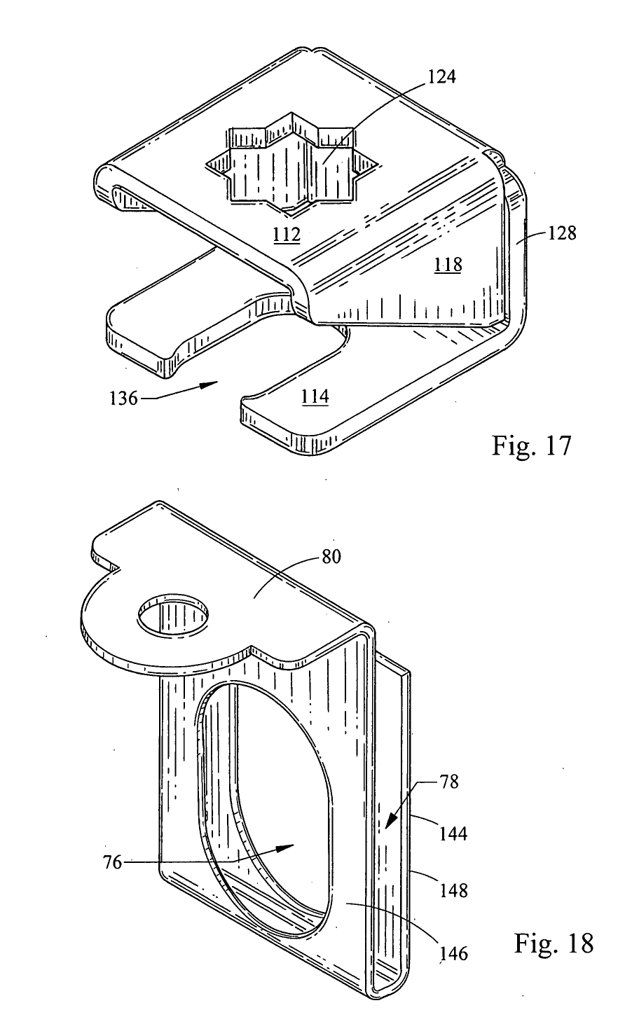

The slot 126 in the lower flange can be oriented in a number of different ways. For example and without limitation, the slot can be elongated perpendicular to the mounting rail, for example as a D-shaped opening 134 as shown in FIGS. 11 and 16. The slot 136, 142 can be open to the front of the lower flange 114, 122 as shown in FIGS. 15 and 17, with the lower flange 122 being shorter than the upper flange 112 in the embodiment of FIG. 15. The slot 138, 140 can be oriented at an oblique angle to the mounting rail, as shown in FIGS. 13 and 14, and can be circumscribed as shown in FIG. 13 or open to a side of the lower flange as shown in FIG. 14.

As shown in FIGS. 11, 12 and 18, in one embodiment a retainer clip 144 is engaged over the lower flange 114. The clip has a pair of spaced apart flanges 146, 148 that form a channel 78 that engages the lower flange 114 of the mounting portion. Aligned, elongated openings or slots 76 are formed in the flanges of the retainer clip. The clip is positioned such that its slots 76 cooperate with the slot 126 in the lower flange to form an opening shaped to receive the shaft of the hook. The retainer clip thereby stabilizes the hook and holds it in position. The retainer clip can be retained with the same screw 132 inserted through a mounting flange 80 used to secure the mounting portion to the retainer. It should be understood that in some embodiments, the retainer clip is not used.

In one sequence of installation, where the retainer clip is omitted, the mounting portion 110 is first secured to the retainer 108 by tightening the screw 132. The hook 6 is thereafter installed as described below. In another embodiment, where the retainer clip 144 is used, the hook 6 is first installed through the mounting portion 110 and retainer clip 144 and then the screw 132 is tightened. If necessary, a separate screw can be used to secure the retainer clip to the mounting rail 2, for example by flipping the retainer clip 144 upside down such that the mounting flange 80 and hole therethrough are located adjacent a bottom side of the mounting rail. In this way, the retainer clip can be left loose, and rotated as necessary, while the hook 6 is installed, with the mounting portion already secured to the mounting rail in a rigid condition. Once the hook is installed, the retainer clip is then secured to the mounting rail with another fastener, or by other means including for example and without limitation a snap fit, bent-tab, detent, welding and the like, or combinations thereof.

Preferably, a plurality of mounting members 4 are arranged along the length of the mounting rail 2 at predetermined, desired locations. In operation, the installer selects one or more hook members 6 from an inventory. The hook members may be different lengths, have different hook portions, etc. as desired. The installer then installs each hook by threading the free end 52 of the hook portion 48 through the opening(s) 32, 124, 126, then threading the shaft 34 through the opening(s) 32, 124, 126 and finally positioning the locator 46 in the opening 32, 124 at a desired rotational setting. During the threading operation, the hook member 6 is moved from a disengaged position to an engaged position without breaking the plane 5 with any portion of the hook member 6. As shown in FIGS. 1 and 2, the locator 46 can be engaged with the opening 32 such that the hook member 6 is positioned parallel to the mounting rail 2 (when viewed from the top as shown in FIG. 2), perpendicular to the mounting rail or obliquely relative to the mounting rail. In all of these positions, the locator 46 is mated with the opening 32 in an engaged position such that no rotation is permitted therebetween.

To change the angular position of the hook member 6 relative to the mounting rail 2, the installer, or operator, simply lifts the hook upwardly such that the locator 46 is disengaged from the opening 32, 124, whereinafter the hook member can be rotated to a new desired position, with the hook member 6 then being released or moved from the disengaged position to an engaged position. In this way, the hook member(s) can be easily moved to any desired position, both along the mounting rail and also rotationally relative to the rail. For example, if the hook members are not needed for tie down, they can simply be rotated to a parallel position adjacent the mounting rail such that they do not interfere with the operator. Of course, if needed, the hook member(s) can also be removed entirely from the mounting rail and stored in another location.

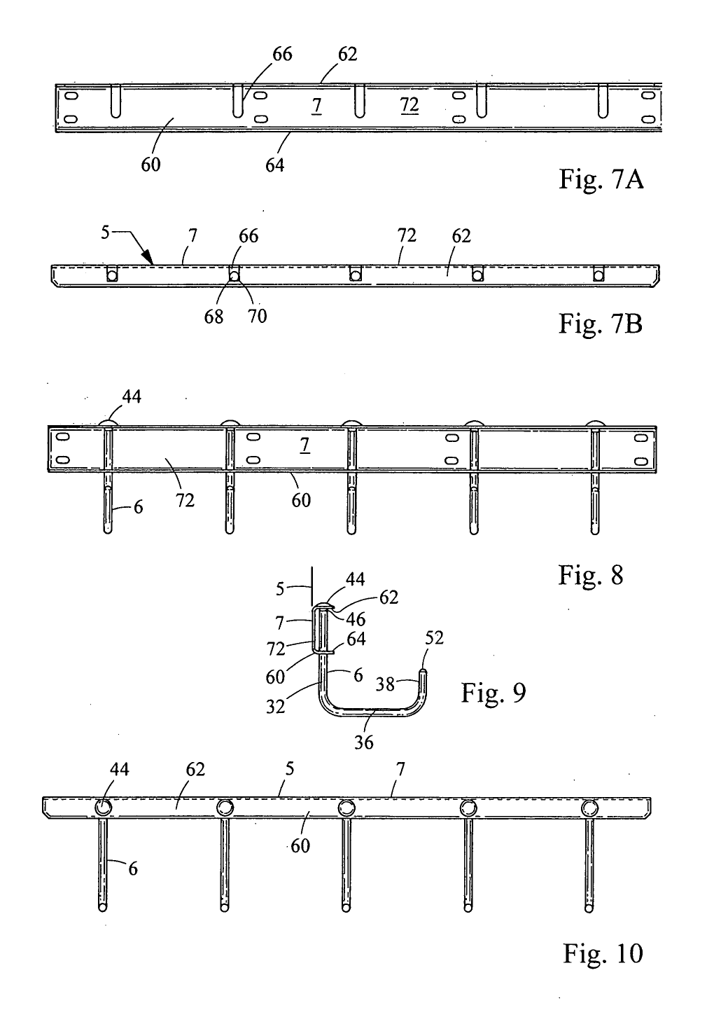

Referring to the embodiment of FIGS. 7-10, the mounting rail 60 does not include outboard, downwardly extending flanges, but rather only spaced apart upper and lower flanges 62, 64 and a rear wall 117. A plurality of L-shaped slots 66 are formed in the upper flange and a vertical wall. A hole 68 is formed in the lower flange in alignment with the most outward portion of the slot in the upper flange. The end 70 of the slot in the upper flange is configured with a non-rotational locator shape, shown as a polygonal shape, e.g. two right angles.

In operation, and during installation, the hook portion 48 is first threaded through the slot 66 in the upper flange 62 and then through the opening 68 in the lower flange 64 until the locator 46 is engaged with the locator portion 70 of the slot. Again, the hooks can be easily moved from an engaged position to a disengaged position and back again as desired without breaking the plane 5. In this embodiment, the location of the hook members is predetermined by the location of the slots 66 and openings 68 formed in the mounting rail.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A hook assembly comprising:
a mounting rail extending in a longitudinal direction;
a retainer slideably coupled to said mounting rail, wherein said retainer is slideable along said mounting rail in said longitudinal direction to a plurality of positions, said retainer having an opening defining a substantially vertical axis; and
a hook member removeably secured to said retainer through said opening, wherein said hook is moveable through said opening from a disengaged position to an engaged position while said retainer is coupled to said mounting rail.

2. The hook assembly of claim 1 wherein said mounting rail comprises a channel having a C-shaped cross section, wherein said retainer comprises an insert portion disposed in an interior of said channel and a mounting portion coupled to said insert portion and disposed outwardly from said channel.

3. The hook assembly of claim 1 wherein said mounting portion is releasably secured to said insert portion.

4. The hook assembly of claim 1 wherein said hook member comprises a J-shaped hook having a vertical shaft and a head portion, wherein said vertical shaft extends through said opening and said head engages said mounting portion when said hook is in said engaged position.

5. The hook assembly of claim 1 wherein said opening has a first polygonal shape, and wherein said head portion comprises a locater having a second polygonal shape mating with said first polygonal shape.

6. The hook assembly of claim 5 wherein said first polygonal shape is a star shape.

7. The hook assembly of claim 5 wherein said second polygonal shape is a square shape.

8. The hook assembly of claim 1 wherein said retainer comprises a lock member releasably securing said retainer to said rail in at least one of said plurality of positions.

9. The hook assembly of claim 8 wherein said lock member comprises a set screw.

10. The hook assembly of claim 1 wherein said retainer comprises vertically spaced apart upper and lower flanges, wherein said opening comprises a first opening formed in said upper flange, and wherein said lower flange has a second opening vertically aligned with said first opening.

11. The hook assembly of claim 10 wherein said first opening has a first shape and said second opening has a second shape different from said first shape.

12. The hook assembly of claim 11 wherein said second opening comprises a slot.

13. The hook assembly of claim 12 wherein said slot communicates with an edge of said lower flange and is open along a portion thereof.

14. The hook assembly of claim 12 wherein said slot has a D-shape.

15. The hook assembly of claim 12 wherein said slot forms an oblique angle with said longitudinal direction.

16. The hook assembly of claim 10 further comprising a retainer clip disposed over said lower flange, said retainer clip comprising an opening aligned with said second opening.

17. A hook assembly comprising:
a mounting member comprising vertically spaced upper and lower flanges, said upper flange having a first opening and said lower flange having a second opening aligned with said first opening in said vertical direction, wherein said first opening has a first shape and said second opening has a second shape, wherein said first shape is different than said second shape; and
a hook member comprising a head portion and a hook portion, wherein said hook member is removeably secured to said mounting member through said first and second openings, wherein said hook portion of said hook member is moveable through said first and second openings as said hook member is moved from a disengaged position to an engaged position, and wherein said head portion engages said upper flange when said hook member is in said engaged position.

18. The hook assembly of claim 17 wherein said first opening has a first polygonal shape, and wherein said head portion comprises a locater having a second polygonal shape mating with said first polygonal shape.

19. The hook assembly of claim 18 wherein said first polygonal shape is a star shape.

20. The hook assembly of claim 19 wherein said second polygonal shape is a square shape.

21. The hook assembly of claim 17 wherein said first shape comprises a star-shape.

22. The hook assembly of claim 17 wherein said second opening comprises a slot.

23. The hook assembly of claim 22 wherein said slot communicates with an edge of said lower flange and is open along a portion thereof.

24. The hook assembly of claim 22 wherein said slot has a D-shape.

25. The hook assembly of claim 22 wherein said slot forms an oblique angle with said longitudinal direction.

26. The hook assembly of claim 17 wherein said first opening comprises a slot.

27. The hook assembly of claim 26 wherein said slot comprises a first slot, and wherein said mounting member comprises a vertical flange connecting said upper and lower flanges, wherein said vertical flange comprises a second slot communicating with said first slot.

28. The hook assembly of claim 27 wherein said second opening comprises a round opening.

29. The hook assembly of claim 17 further comprising a retainer clip disposed over said lower flange, said retainer clip comprising an opening aligned with said second opening.

30. A method of assembling a hook assembly comprising:
mounting a mounting member to a surface defining a plane;
successively threading a hook portion and a shaft portion of a J-shaped hook member through an opening in said mounting member without breaking said plane with said hook member; and
engaging said mounting member with a head portion of said hook member.

31. The method of claim 30 wherein said mounting said mounting member comprises sliding said mounting member along a rail in a longitudinal direction to a predetermined position.

32. The method of claim 31 wherein said mounting rail comprises a channel having a C-shaped cross section, wherein said mounting member comprises an insert portion disposed in an interior of said channel and a mounting portion coupled to said insert portion and disposed outwardly from said channel.

33. The method of claim 31 further comprising releasably securing said mounting member to said rail at said predetermined position.

34. The method of claim 30 wherein said opening has a first polygonal shape, and wherein said head portion comprises a locater having a second polygonal shape mating with said first polygonal shape, and wherein said engaging said mounting member with a head portion of said hook member comprises inserting said locater into said opening.

35. The method of claim 34 wherein said first polygonal shape is a star shape.

36. The method of claim 34 wherein said second polygonal shape is a square shape.

37. The method of claim 30 wherein said mounting member comprises vertically spaced apart upper and lower flanges, wherein said opening comprises a first opening formed in said upper flange, and wherein said lower flange has a second opening vertically aligned with said first opening, and wherein said successively threading said hook portion and said shaft portion of said J-shaped hook member through said opening in said mounting member without breaking said plane with said hook member comprises successively threading said hook portion and said shaft portion of said J-shaped hook member through said first opening and then through said second opening.

38. The method of claim 37 wherein said first opening has a first shape and said second opening has a second shape different from said first shape.

39. The method of claim 38 wherein said second opening comprises a slot.

40. The method of claim 39 wherein said slot communicates with an edge of said lower flange and is open along a portion thereof.

41. The method of claim 40 wherein said slot has a D-shape.

42. The method of claim 40 wherein said slot forms an oblique angle with said longitudinal direction.
